(19) United States
(12) Patent Application Publication
(10) Pub. No.: US 2015/0046263 A1
(43) Pub. Date: Feb. 12, 2015

(54) METHOD FOR PROVIDING ADVERTISING CONTENT USING MOBILE MESSENGER

(71) Applicant: ADRRA CO., LTD., Seoul (KR)

(72) Inventor: Jang Won Seo, Seoul (KR)

(21) Appl. No.: 14/522,518

(22) Filed: Oct. 23, 2014

Related U.S. Application Data
(63) Continuation-in-part of application No. PCT/KR2013/003397, filed on Apr. 22, 2013.

(30) Foreign Application Priority Data
Apr. 23, 2012 (KR) 10-2012-0041895

(51) Int. Cl. G06Q 30/02; H04L 12/58; H04M 3/487; G06F 3/0488; H04M 1/725

(52) U.S. Cl. CPC G06Q 30/0267; G06F 3/04886; H04M 1/72552; H04M 3/4878; H04L 51/04
USPC 705/14.64

(57) ABSTRACT

Provided is a method of providing commercial content by a mobile messenger in a mobile device. The method includes: receiving a request to start the mobile messenger; displaying a virtual keyboard in a virtual keyboard region of a display unit of the mobile device as a virtual input unit, wherein the virtual keyboard is adapted to receive user input indicating a first message to be sent to a recipient; and displaying commercial content on at least a portion of the virtual keyboard region during a standby state after the first message is sent to the recipient and before a first response message is received from the device of the intended recipient.

### CROSS-REFERENCE TO RELATED APPLICATIONS

This patent document is a continuation-in-part application claiming priority under 35 U.S.C. §§120 and 365 (c) to the Korean PCT Application No. PCT/KR2013/003397, entitled “METHOD FOR PROVIDING ADVERTISING CONTENT USING MOBILE MESSENGER” and filed on Apr. 22, 2013, which claims priority of Korean Patent Application No. 10-2012-0041895, entitled “METHOD OF PROVIDING COMMERCIAL CONTENT USING MOBILE MESSENGER” and filed on Apr. 23, 2012, which are incorporated herein by reference in their entirety.

### TECHNICAL FIELD

This patent document relates to a method of providing commercial content by using a smart device.

### BACKGROUND

As a smart phone or tablet PC market becomes the core of mobile industry, a mobile communication service that is based on a typical feature phone has went through a lot of changes. As one example of such change, many types of applications have been developed and distributed. Such applications provide users with a lot of convenience and usefulness. For example, a conventional SMS or MMS service that many users use requires users to make a payment and a mobile communication company has earned enormous profits. However, as a free messenger application is developed and distributed, users send text messages by using the messenger application rather than a conventional payment-based SMS service.

A mobile messenger application provides a mobile instant message (MIM) service. Such a messenger application includes KakaoTalk™ or Mypeople™. Since it provides the same effect as a SMS or MMS service for free, users become enthusiastic about the messenger application. Therefore, an operator that supplies the application has obtained many subscribers. However, as the messenger application has many subscribers, an operator that supplies and manages the mobile messenger application had to bear expenses that are needed for maintaining connections from many subscribers, processing data, and managing a system. Thus, the operator need to have a profit model. However, although the mobile messenger application attract many loyal subscribers, there was no successful business model through which a profit can be earned.

### SUMMARY

One implementation of the disclosed technology is to provide a method that may provide a profit model for an operator that supplies and manages a mobile messenger application. It relates to the distribution of commercial content.

One implementation of the disclosed technology is to provide a method of minimizing mental resistance with regard to viewing commercial content through his or her smart device.

Other implementations will be additionally made within a scope that may be easily inferred from the following detailed description and the effect.

According to one aspect, there is provided a method of providing commercial content by using a mobile messenger installed in a smart device. The method may include: (a) receiving a request to start the mobile messenger; (b) displaying a virtual keyboard in a virtual keyboard region of a display unit of the mobile device as a virtual input unit, wherein the virtual keyboard is adapted to receive user input indicating a first message to be sent to a recipient; and (c) displaying commercial content on at least a portion of the virtual keyboard region during a standby state after the first message is sent to the recipient and before a first response message is received from the device of the intended recipient.

In some implementations, the method may further include, responsive to receiving the first response message from the recipient, stopping the display of the commercial content on the virtual keyboard region.

In some implementations, wherein the commercial content displayed on at least a portion of the virtual keyboard region is pre-stored in a memory of the smart device.

In some implementations, the method may further include connecting to a remote server to communicate information associated with an exposure of the mobile device to the commercial content including a number of times the mobile device is exposed to the commercial content.

In another aspect, there is provided a method of providing commercial content by using a mobile messenger in a smart device. The method includes: receiving a request to start the mobile messenger; sending a message including non-text information including an URL address or a file stored in a memory of the mobile device to a recipient, wherein the message is received through a virtual keyboard displayed in a virtual keyboard region displayed on the mobile device; and (3) displaying commercial content on at least a portion of the virtual keyboard region after the sending of the message and before receiving a response message from the recipient.

In some implementations, the method may further including, responsive to receiving the response message from the recipient, stopping the display of the commercial content on the virtual keyboard region.

In some implementation, the commercial content displayed on at least a portion of the virtual keyboard region is pre-stored in a memory of the smart device.

In some implementations, the method may further include connecting to an external server to communicate information associated with an exposure of the mobile device to the commercial content including a number of times the mobile device is exposed to the commercial content. In another aspect, there is provided a method of providing commercial content by a mobile messenger in a mobile device including: receiving a request to start the mobile messenger; displaying a virtual keyboard on a virtual keyboard region of a display unit of the mobile device to receive user input indicative of a message to be sent to a recipient; and sending the message to the recipient; and displaying commercial content on the virtual keyboard region, wherein commercial content is stored in the smart device or obtained from a remote server, during an idle state in which an input is not received through the virtual keyboard region.

In some implementations, the commercial content may include a text, an image, or a video.

In some implementations, the smart device may include a smart phone, a tablet PC, and a smart TV.

In some implementations, a mobile device for providing commercial content is provided to include: a processor; and a display unit configured to: display a virtual user interface configured to receive user input indicating a message to be sent to a recipient; display commercial content on at least a part of an area used to display the user interface responsive to a request to send the message to the recipient; and responsive to receiving a response message from the recipient, ceasing the display of the commercial content and displaying the user interface to receive additional input indicative of another message to be sent.

In some implementations, the message includes non-text information including a URL address or a file.

In some implementations, the processor is configured to execute a mobile messenger; and the mobile messenger is configured to determine whether the received input indicative of a message to be sent to a recipient is a first message starting a chat with the recipient before displaying the commercial content.

In another aspect, a mobile device for presenting commercial content is provided to comprise: a processor; and a display unit including a portion of the displayable area that can be used to selectively display commercial content or a virtual keyboard for receiving user input indicative of a message to be sent to a recipient; wherein the display unit is configured to display information indicative of a benefit received from a remote server based at least on information exchanged with the remote server associated with a number of times the commercial content is displayed on the display unit of the mobile device.

In some implementations, the display unit is configured to display updated commercial content received from the remote server.

In some implementations, the display unit is configured to display a replacement commercial content.

In some implementations, the commercial content displayed on at least a portion of the virtual keyboard region is obtained from a remote server.

In some implementations, the remote server includes a mobile messenger provider server, or a commercial content server.

In some implementations, the method further includes receiving compensation from the remote server based on the number of times the mobile device is exposed to the commercial content.

In some implementations, the commercial content displayed on at least a portion of the virtual keyboard region is obtained from a remote server.

In some implementations, the method further includes receiving compensation from the remote server based on the number of times the mobile device is exposed to the commercial content.

According to an implementation of the disclosed technology, it is possible to provide a profit model to a mobile messenger operator. Accordingly, the mobile messenger operator can maintain the current service and afford the expenses needed for providing another service. Also, it is possible to build a new commercial market by securing a new commercial item for mobile commercial and thus, industrial applicability is very high.

Also, according to an implementation of the disclosed technology, while a message is sent and received in real time by using a mobile messenger, a virtual keyboard region located on the screen of a smart device is used for displaying commercial during a standby or idle period. Since no conversation is communicated between users during the standby or idle period, there is an advantage in that a user is never bothered. Thus, it is possible to minimize mental resistance to viewing commercial content. Moreover, since the commercial content is anyhow displayed without bothering a user, advertising effects can improve.

It should be noted that effects not mentioned explicitly herein but described in the following description expected by the technical characteristic of the disclosed technology may be and their potential effects are handled as being described in the present disclosure.

### BRIEF DESCRIPTION OF THE DRAWINGS

The above objects, other features and advantages of implementations of the disclosed technology will become more apparent by describing embodiments thereof with reference to the accompanying drawings, in which:

FIG. 1 represents an exemplary screen 100 for inputting a message using a mobile messenger;

FIG. 2 represents an exemplary mobile messenger screen 100 that displays commercial content 140 on a virtual keyboard region 130 according to one embodiment of the disclosed technology;

FIG. 3 represents an exemplary mobile messenger screen 100 that removes the commercial content 140 in FIG. 2 upon receiving a response message;

FIG. 4 represents an exemplary mobile messenger screen 100 that displays commercial content 141 on a virtual keyboard region 130 according to another embodiment of the disclosed technology;

FIG. 5 represents an exemplary mobile messenger screen 100 that removes the commercial content 141 in FIG. 4 upon receiving a response message;

FIG. 6 is an exemplary flow chart for implementing an advertising method according to one embodiment of the disclosed technology;

FIG. 7 is an exemplary flow chart for implementing an advertising method according to another embodiment of the disclosed technology; and

FIG. 8 illustrates a schematic configuration of an exemplary system of the disclosed technology.

It should be noted that the accompanying drawings are presented as references for the understanding various implementations of the disclosed technology, and the scope of rights of the disclosed technology is not limited thereby.

### DETAILED DESCRIPTION

Embodiments of the disclosed technology are described below in detail with reference to the accompanying drawings. In addition, detailed descriptions related to well-known functions or configurations will be omitted to the extent that they may make implementations of the disclosed technology unnecessarily obscure in describing the implementations.

A mobile instant message (MIM) may be sent and received without payment by using a mobile messenger application. In order for a user to use the MIM, he or she has to install the mobile messenger application on his or her mobile device, such as a smart device. A typical provider of the mobile messenger application includes KakaoTalk™ or Mypeople™. A mobile device that includes a mobile messenger application can generally include a processor (e.g., a central processing unit) for executing various applications including the mobile messenger applications. The mobile device also includes a display unit, such as a liquid crystal display (LCD), organic light emitting diodes (OLED), etc. The mobile device can also include physical user interface device such as physical button, dials, keys, wheels, etc. in one aspect, the processor can execute the mobile messenger application to display a virtual user interface on at least a portion of the display unit. The virtual user interface can include a virtual keyboard for receiving user input. On the same portion of the display unit where the virtual keyboard is displayed, commercial content can be selectively displayed as described in this patent document. The mobile messenger application may provide information on other users and a list of other users that are “friends” of a user of the smart device, and may select one or more of the friends to send and receive a message in real time.

The mobile messenger application is optimized for the operating system (OS) of the smart device. For inputting and sending a message, a mobile messenger does not need to provide its own input means, and calls and uses a virtual keyboard that is already set on the smart device by the OS of the smart device. For example, the smart device includes a mobile computing device having a call function, such as a smart phone or a tablet PC, or a smart TV linked to the smart phone or the tablet PC, which has a virtual keyboard as a software input means.

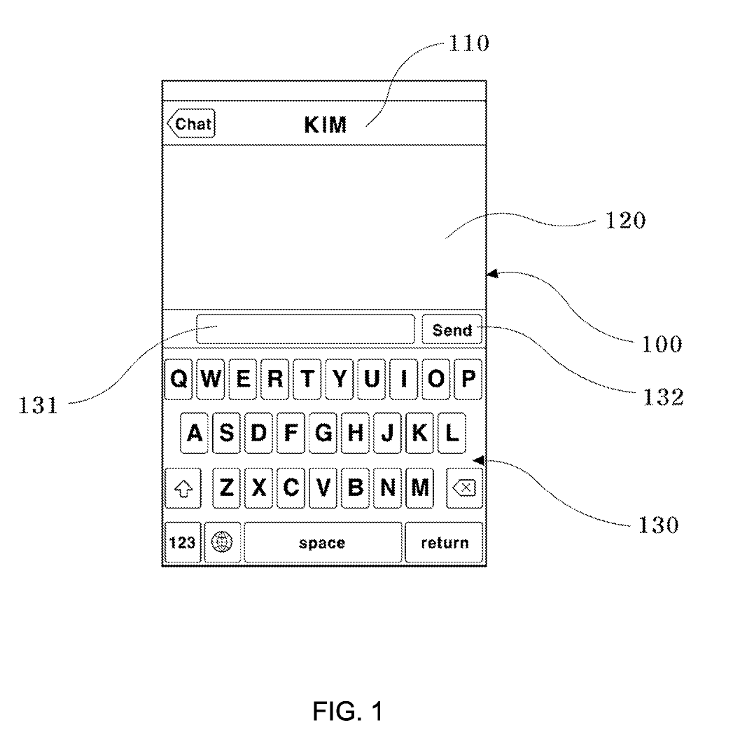

FIG. 1 represents a configuration example of a screen of a mobile messenger for sending a text message. A mobile messenger screen 100 includes a recipient region 110, a message region 120, and a virtual or graphical user interface region (e.g., virtual keyboard region) 130 that operates as an input means. A user enters input including a text, a symbol, or a number using the input window 131 of the virtual keyboard region 130 and clicks a send button 132 to send a message to a recipient (e.g., the message is addressed to an account, such as a phone number, account ID, email ID, or even a device associated with the recipient). The input entered or the message sent is displayed on the message region 120. In one implementation, a message sent from a sender may be arranged on the right side and a message sent from a recipient may be arranged on the left side.

The virtual keyboard of the smart device called by the mobile messenger is maintained or displayed as an activated state as long as the screen in FIG. 1 is provided to the user. By doing so, the user can quickly send and receive a message. Thus, the virtual keyboard is continuously displayed on the screen as in FIG. 1 until the transmission or reception of the message finishes and other screens such as a main screen or a selection screen are provided to the user.

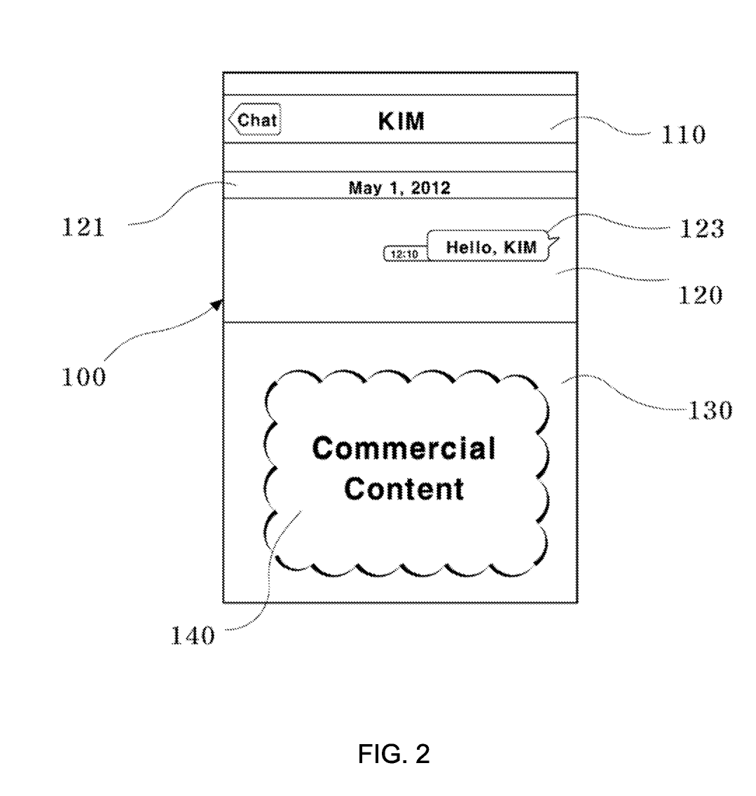

FIG. 2 represents a screen to explain an exemplary scenario according to one embodiment of the disclosed technology. FIG. 2 shows an example of a screen that is provided when or after a user inputs or writes a message “Hello, KIM” that is to be sent to a recipient. the message sent is represented in a speech bubble 123, which is indicated on a sender side, in the message region 120. The speech bubble 123 may display a time at which the message has been sent, and a date region 121 may display a date on which the message has been sent.

At this time, the virtual keyboard region 130 does not disappear and remains on the mobile messenger screen 100. On the recipient side, the message has just arrived and it may take some time for the recipient to respond to the message. There usually exists a certain standby time before the user sending a first message receives a first response message from the recipient after the user sends the first message.

During the standby time, as long as a user does not close the mobile messenger screen 100, the virtual keyboard region 130 is activated or displayed on the mobile messenger screen 100. According to an implementation of the disclosed technology, commercial content is displayed on the screen of a device which is in an idle state not performing any functions. As shown in FIG. 2, the commercial content region 140 is located in the virtual keyboard region 130. The commercial content region 140 may occupy a whole or a portion of the virtual keyboard region 130.

In an embodiment where the commercial content is displayed on the whole of the virtual keyboard region 130, it is possible to maximize an advertising effect by displaying the commercial content on the whole of the keyboard region and temporarily stopping an input operation. In this case, a modification can be made such that the commercial content disappears when the user clicks the commercial content. Alternatively, other modification can be made such that the commercial content disappears when the user clicks a specific mark or a specific portion displayed on the screen. In an embodiment where the commercial content is displayed on a portion of the virtual keyboard region 130, it is possible to allow a user to immediately input another message subsequent to the first message. For example, only some portions of the virtual keyboard region 130, including the input box or the send button, are displayed on the screen of the device, while the commercial content is displayed on the remaining portion of the virtual keyboard region 130. In this case, if a user clicks on the portion of the virtual keyboard region 130 including the input box or the send button, the commercial content disappear and the device is changed to a keyboard input standby state.

The commercial content displayed on the virtual keyboard region 130 may be or include a text, an image or a video, or the combinations thereof

In consideration of an environment in which a user uses the smart device, the commercial content may be displayed for a short time. As one example, the commercial content may have a running time of approximately 3 seconds to 10 seconds. Also, when the response message is received from the recipient, the commercial content may not be displayed any longer. If the commercial content is still displayed even when the user receives the response message, it may cause displeasure in the user. Thus, the virtual keyboard is displayed on the screen at this time such that the user can send a response message to the recipient, if necessary.

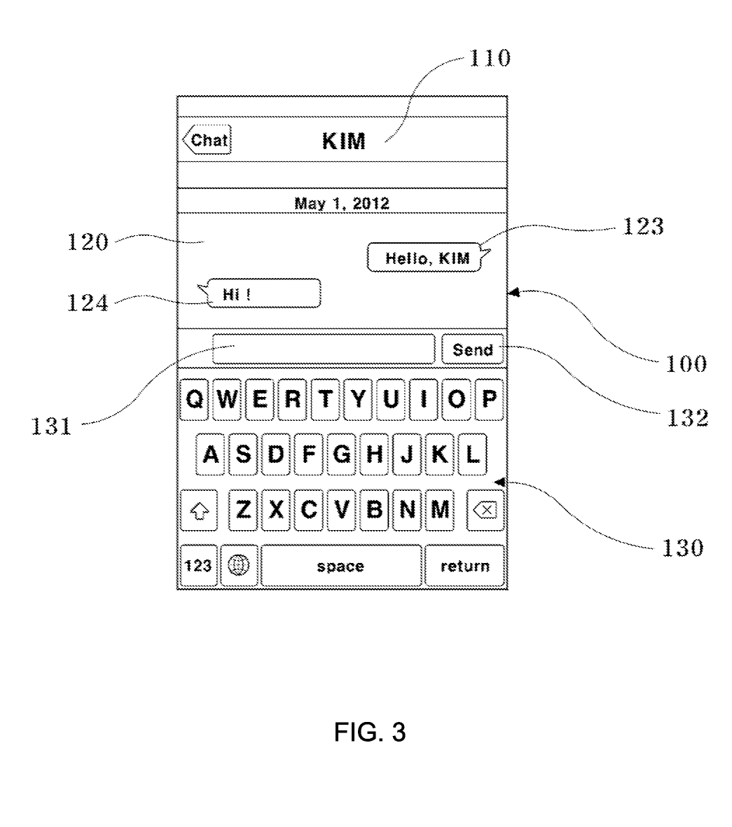

FIG. 3 is an exemplary screen that allows a user to send a response message to the recipient. A first response message from the recipient is represented in a speech bubble 124. The user and the recipient are now chatting in real time. Since the virtual keyboard is provided in the virtual keyboard region 130 upon receiving the first response message, it is possible for the user to immediately communicate with the recipient through a message. If commercial content is displayed when the user receives the response message from the recipient, this may cause severe displeasure and inconvenience. Thus, the commercial content that is included in FIG. 2 is not displayed in FIG. 3.

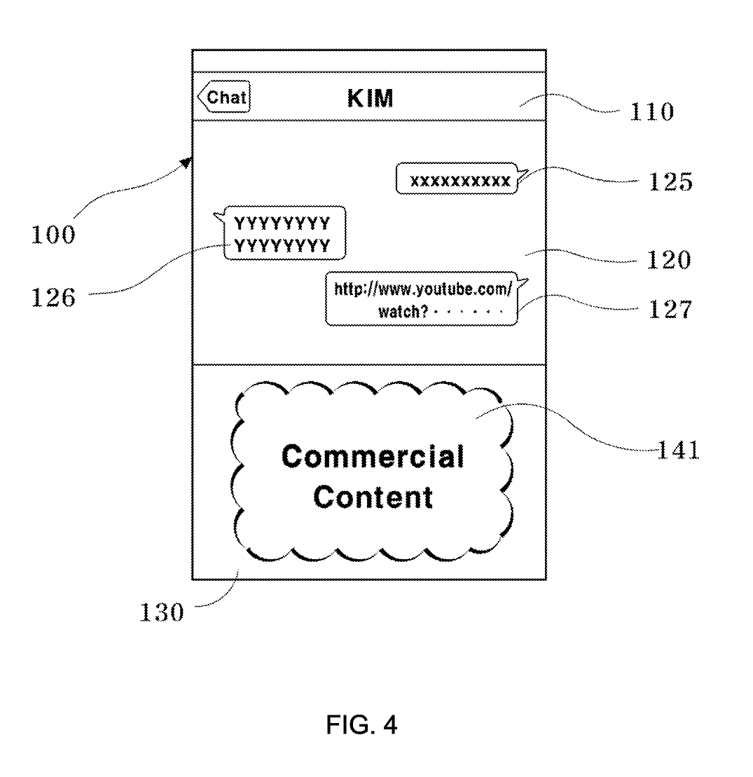

FIG. 4 shows a screen according to another embodiment of the disclosed technology. The sender and the recipient communicate to each other through messages. Messages sent from the user of the smart device are displayed in right sided speech bubbles 125 and 127 and messages sent from the recipient are displayed in a left sided speech bubble 126.

In this embodiment, a file stored in the smart device or URL address information is sent through a mobile messenger. When URL address information, for example, providing a link to a video, is sent from the user, it takes time for the recipient to view the video after the user sends URL address information. For example, when the URL information providing a link to a YouTube video is sent to the recipient, it takes time for the recipient to perform operations necessary for viewing the video including clicking the URL information, activating the link, opening the URL address, performing buffering and view the video on his or her device. In conventional messenger applications, under this situation, the virtual keyboard region 130 is continuously displayed on the screen of the user device. According to an implementation of the disclosed technology, however, since the virtual keyboard is in an idle state in which the virtual keyboard is not used to enter any inputs, the commercial content 141 instead of the virtual keyboard is displayed on the virtual keyboard region 130. As explained above, a whole or portion of the virtual keyboard region 130 may operate as the commercial content region 140.

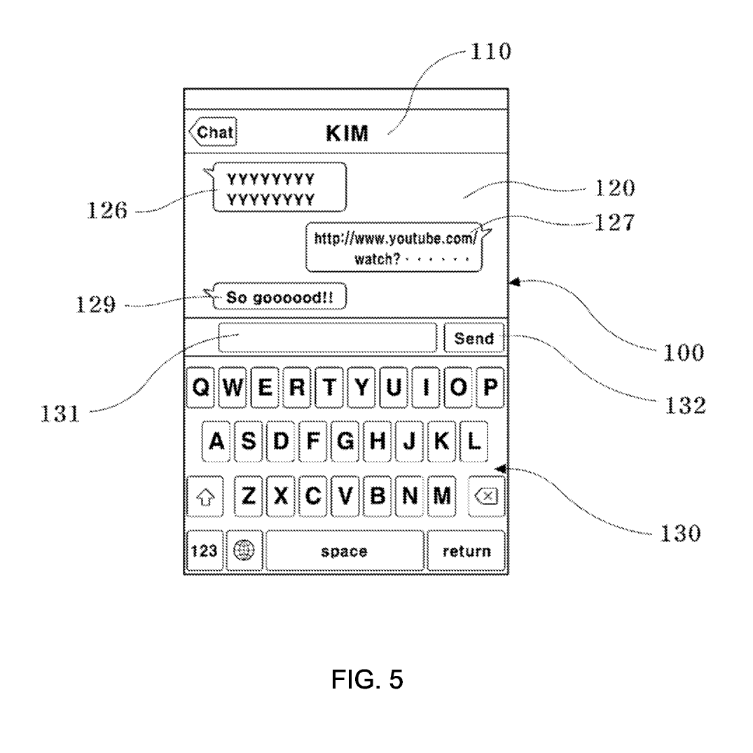

The commercial content 141 can have a running time of approximately 3 seconds to 10 seconds as same in the above embodiment. when a response message is received from the recipient, the commercial content may disappear. FIG. 5 represents an exemplary screen when a response message “So gooooood!” is received from the recipient through the speech bubble 129. Upon receiving the response message, the display of commercial content ends and the virtual keyboard region 130 providing the virtual keyboard again appears.

Commercial contents displayed on the virtual keyboard region may be pre-stored in a memory of the smart device. The commercial contents may be previously downloaded by a separate medium (commercial content application) and moved to the smart device. Alternatively, commercial contents may be previously downloaded through a mobile messenger application that is installed in the smart device. The commercial content may be regularly replaced. For example, when the smart device connected to a network, for example, wireless internet such as WiFi, it is possible to download new commercial content from a commercial content server and replace existing commercial content.

In some implementations, the commercial content may be stored in a database of a mobile messenger provider server (or a commercial content server). After a chatting channel is opened or established on an application program, shortly before the user sends the first message or shortly before the user sends the file or URL address, a mobile messenger server may display commercial content on the virtual keyboard region on the user device. In the case of a video, the mobile messenger server may stream the video to the virtual keyboard region. In such a case, commercial content (that may be changed on a server side) may be preset by default to have a display time and a display region.

The virtual keyboard region 130 may include a keyboard implemented in software on a smart device, and is keyed-in by a user's touch or other various input methods.

The embodiment in FIG. 4 provides an exemplary screen on which URL information is input by the user and sent to the recipient. When clicking the URL information, a web page to which a video, text or image is linked may be loaded. It may be considered as sending a file linked on a web, for example. Alternatively, the user can send a file stored in his or her smart device. The file search interface has been kept changing and being developed on a smart device such as a smart phone or a tablet PC, and thus, the exemplary screen of FIG. 4 does not show a file search interface. However, the file search interface can be provided in various manners. For example, first, an icon may be displayed on the screen of FIG. 4. The icon may be applied to the embodiment shown in FIG. 4. Second, a file transfer function may be selected on other screens, for example, screen for viewing items such as a picture, video or text (such as a memo, text file, and e-book, and may be sent through a mobile messenger. Using other screens may be applied to the embodiment shown in FIG. 2. The executing of the mobile messenger and the sending of a first message (file transfer message) may be simultaneously performed and commercial content may be displayed on the virtual keyboard region.

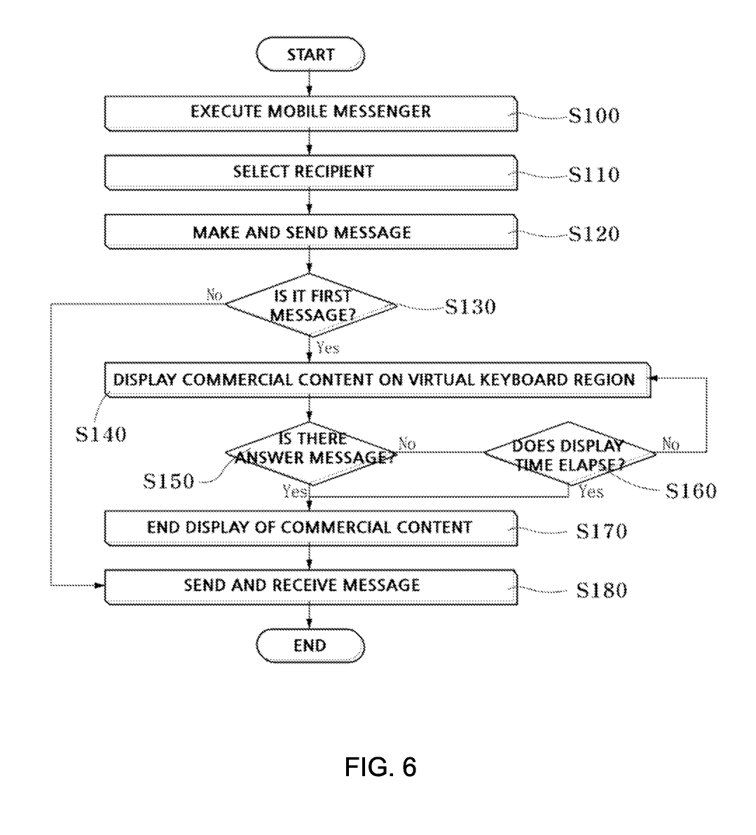

FIG. 6 represents an exemplary flowchart including processes of a method of providing commercial content according to one embodiment of the disclosed technology. A mobile messenger application is previously installed in a smart device. The mobile messenger application may also be already included in the OS of the smart device. Before and after the mobile messenger application is installed in the smart device, at least one commercial content may be stored in a memory of the smart device (referred to as a first case related to the storage location of the commercial content). Alternatively, one or more commercial contents may be stored in a commercial content database of a remote server, such as a mobile messenger provider server (or commercial content server) side (referred to as a second case related to the storage location of the commercial content).

First, a mobile messenger is executed on the smart device in step S100. The user selects a mobile messenger icon represented on the screen of the smart device to execute the mobile messenger. When or after the mobile messenger is executed, a list of recipients to which a text message is sent is represented on screens including a main screen or a sub screen. A recipient is selected in step S110.

A recipient is selected. For inputting a message that is to be sent to the selected recipient, the smart device displays a virtual keyboard on the screen. When a message for the recipient is input using the virtual keyboard and a send button is clicked, the smart device sends the message to the recipient in step S120.

The message is defined as a first message with a single-cycle. In this example, the single cycle is defined as time between start and end of the transmission of a series of messages that are communicated during a chat. In one implementation, the single cycle may be set using a time interval. For example, the single cycle may be set in various manners as follows. (In the example below, time used for defining one cycle can be varied.):

\textcircled{1} In one implementation, one cycle may be set as time from when a first message starting a chat is sent to a specific recipient to one hour after a last message completing the chat is sent (In this case, if another message is sent beyond one hour after the last message is sent, the message is defined as another first message with a new single cycle.).

\textcircled{2} In one implementation, one cycle may be defined for a case when two hours have elapsed since the user received a message from a specific recipient. In this case, one cycle may be set as time from when a first message (responding to the message received) is sent to that recipient to one hour after a last message is sent.

\textcircled{3} In one implementation, one cycle may be set as time from when commercial content is displayed on the screen to when one hour has elapsed thereafter.

\textcircled{4} In one implementation, different cycles are defined for different recipients.

The smart device determines in step S130 whether the message transmitted in step S120 is a first message with a single-cycle that is set, for example, according to one of implementations above, and if it is determined that the message transmitted in step S120 is the first message, displays commercial content on the virtual keyboard region in step S140.

The smart device determines in step S150 whether a response message has arrived from a recipient side, for example, his or her smart device. If it is determined that the response message has arrived, the display of the commercial content is forced to cease in step S170 although the preset display time of the commercial content has not elapsed. If it is determined that the response message has not arrived yet, it is determined in step S170 whether the display time of commercial time has elapsed. If it is determined in step S160 that the preset time has elapsed, the display of the commercial content ceases as well in step S170.

Then, a procedure for sending and receiving a message proceeds in step S180.

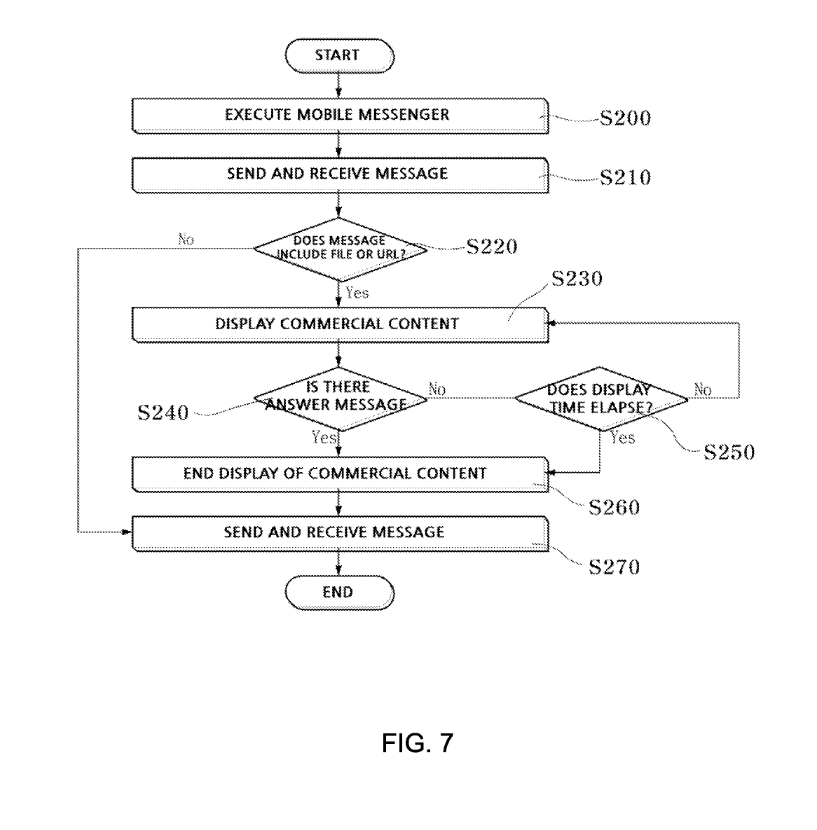

FIG. 7 represents an exemplary flowchart including processes of a method of providing commercial content according to another embodiment of the disclosed technology. The embodiment illustrated in FIG. 7 is similar to the embodiment of FIG. 5. However, the commercial content in the example of FIG. 7 is not displayed by using a concept of a first message with a single cycle. In the embodiment shown in FIG. 7, a file or URL information that is sent from a user using a mobile messenger is considered as a message and commercial content is accordingly displayed.

First, a mobile messenger is executed on a smart device in step S200. Once the mobile messenger is executed, a recipient to which a message is sent is selected. A message is sent and received in real time in step S210. The smart device determines in step S220 whether the message includes a file or URL information.

If it is determined that the message includes the file or URL information in step S220, commercial content is displayed on a virtual keyboard region in step S230. The smart device determines in step S240 whether a response message has arrived from a recipient side, for example, his or her smart device. If it is determined that the response message has arrived, the display of the commercial content is forced to cease in step S260 although a preset display time of the commercial content has not elapsed. If it is determined that the response message has not arrived yet, it is determined in step S250 whether the display time of commercial time has elapsed. If it is determined that the preset time has elapsed, the display of the commercial content ceases as well in step S260. Then, a procedure for sending and receiving a message is performed in step S270.

With regard to the storage location of the commercial content, according to one implementation of the disclosed technology, when various commercial contents are pre-stored, the commercial content is displayed on the virtual keyboard region in a random manner or in a preset order. According to another implementation related to the storage location of the commercial content, the location storage depends on scheduling of a mobile messenger provider sever or a commercial content server. For example, customized commercial content may be displayed based on personal information such as a location, age or sex of a user.

A log record of the display event of commercial content may be recorded in the smart device and sent to the commercial content server, and the record may also be stored in the mobile messenger provider server.

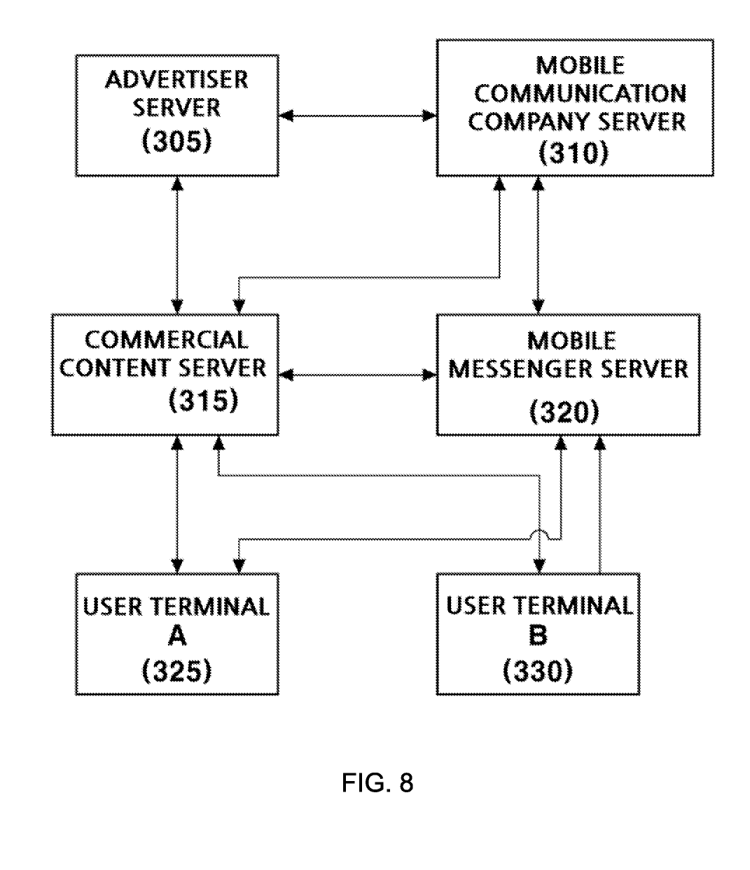

FIG. 8 schematically represents a configuration of an exemplary system 300 for providing commercial content through a mobile messenger according to an embodiment of the disclosed technology. As one example, user terminals may include smart devices.

A mobile messenger server 320 provides a mobile messenger to be installed in a user terminal A 325 or a user terminal B 330 and controls sending and receiving a message between user terminals. In one embodiment, a commercial content server 315 cooperates with the mobile messenger server 320 so that commercial content can be displayed on a screen (for example, a virtual keyboard region) of the mobile messenger. In some embodiments, there is a storage storing the commercial content in the mobile messenger server 320 side, and a database recording the commercial information and log information may be constructed. In one embodiment, the commercial content server 315 may be integrated into the mobile messenger server 320 side.

The advertising content server 315 provides the user terminal A 325 and the user terminal B 330 with the commercial content. Also, payment information may be obtained from the user terminal A 325 and the user terminal B 330 and reported to an advertiser server 305. In addition, the commercial content server 315 may cooperate with the mobile messenger server 320 so that commercial content is stored in a memory of a user terminal when the mobile messenger application is installed in the user terminal A 325 or user terminal B 330. Also, the commercial content server 315 may update or replace the commercial content stored in the user terminals at a certain cycle. In some embodiments, when the mobile messenger installed in the user terminal A 325 or the user terminal B 330 is updated, the commercial content may be updated or replaced at the same time. Also, the commercial content server 305 (or the mobile messenger server 320) may be linked to a mobile communication company server 310 to cover service fees of the user terminals based on the number of times the commercial content is exposed. In one implementation, the commercial content server 305 (or the mobile messenger server 320) can provide a benefit or compensation such as accumulated money or points into a user mobile messenger service fees of a smart device based on the number of times the user terminals (e.g., mobile device associated with the user) is exposed to the commercial content. Accordingly, a business model can be developed, in which a user terminal can benefit from displaying commercial content based on the number of times that the commercial content is exposed.

The user terminal may click the commercial content displayed on the virtual keyboard region of his or her device to move to an advertiser's site linked in commercial content. Also, a purchase event can occur using a link included in the commercial content and a predefined procedure. An application may provide a virtual or graphical user interface for replaying commercial content. In one implementation, the interface for replaying commercial content may be displayed on the screen of a user terminal when a user terminates the mobile messenger. By using the interface, a user can move a link and cause a purchase event to occur. The advertiser server 305 obtains, from the commercial content server 315, the log records of commercial content displayed on the user terminal A 325 or the user terminal B 330. The examples of the log records include a number of exposure times, a frequency of exposure, an exposure time, a number of times a link to the commercial content is selected, or statistical information.

Implementations of the disclosed technology are not limited to the descriptions and expressions of the embodiments explicitly mentioned above. Also, it should be noted that implementations of the disclosed technology may cover a change or replacement obvious in the related arts.

What is claimed is:

1. A method of providing commercial content by a mobile messenger in a mobile device, the method comprising:
receiving a request to start the mobile messenger;
displaying a virtual keyboard in a virtual keyboard region of a display unit of the mobile device as a virtual input unit, wherein the virtual keyboard is adapted to receive user input indicating a first message to be sent to a recipient; and
displaying commercial content on at least a portion of the virtual keyboard region during a standby state after the first message is sent to the recipient and before a first response message is received from the device of the recipient.

2. The method of claim 1, further comprising, responsive to receiving the first response message from the recipient, stopping the display of the commercial content on the virtual keyboard region.

3. The method of claim 1, wherein the commercial content displayed on at least a portion of the virtual keyboard region is pre-stored in a memory of the mobile device.

4. The method of claim 1, further comprising connecting to a remote server to communicate information associated with an exposure of the mobile device to the commercial content including a number of times the mobile device is exposed to the commercial content.

5. The method of claim 4, comprising:
receiving compensation from the remote server based on the number of times the mobile device is exposed to the commercial content.

6. The method of claim 1, wherein the commercial content displayed on at least a portion of the virtual keyboard region is obtained from a remote server.

7. The method of claim 6, wherein the remote server includes a mobile messenger provider server, or a commercial content server.

8. A method of providing commercial content by a mobile messenger in a mobile device, the method comprising:
receiving a request to start the mobile messenger;
sending a message including non-text information including an URL address or a file stored in a memory of the mobile device to a recipient, wherein the message is received through a virtual keyboard displayed in a virtual keyboard region displayed on the mobile device; and
displaying commercial content on at least a portion of the virtual keyboard region after the sending of the message and before receiving a response message from the recipient.

9. The method of claim 8, further comprising, responsive to receiving the response message from the recipient, stopping the display of the commercial content on the virtual keyboard region.

10. The method of claim 8, wherein the commercial content displayed on at least a portion of the virtual keyboard region is pre-stored in a memory of the smart device.

11. The method of claim 8, wherein the commercial content displayed on at least a portion of the virtual keyboard region is obtained from a remote server.

12. The method of claim 8, comprising connecting to an external server to communicate information associated with an exposure of the mobile device to the commercial content including a number of times the mobile device is exposed to the commercial content.

13. The method of claim 12, comprising:
receiving compensation from the remote server based on the number of times the mobile device is exposed to the commercial content.

14. A mobile device for providing commercial content, comprising:
a processor; and
a display unit configured to:
display a virtual user interface configured to receive user input indicating a message to be sent to a recipient;
display commercial content on at least a part of an area used to display the user interface responsive to a request to send the message to the recipient; and
responsive to receiving a response message from the recipient, ceasing the display of the commercial content and displaying the user interface to receive additional input indicative of another message to be sent.

15. The mobile device of claim 14, wherein the message includes non-text information including a URL address or a file.

16. The mobile device of claim 14, wherein the processor is configured to execute a mobile messenger; and the mobile messenger is configured to determine whether the received input indicative of a message to be sent to a recipient is a first message starting a chat with the recipient before displaying the commercial content.

17. The mobile device of claim 14, wherein the virtual interface includes a virtual keyboard for receiving user input indicative of the message to be sent to the recipient.

18. The mobile device of claim 14, wherein the display unit is configured to display information indicative of a benefit received from a remote server based at least on information exchanged with the remote server associated with a number of times the commercial content is displayed on the display unit of the mobile device.

19. The mobile device of claim 14, wherein the display unit is configured to display updated commercial content received from the remote server.

20. The mobile device of claim 14, wherein the display unit is configured to display a replacement commercial content.
